(19) United States
(12) Patent Application Publication
(10) Pub. No.: US 2004/0261280 A1
(43) Pub. Date: Dec. 30, 2004

(54) Color ruler device, method and kit

(75) Inventors: Alexander Paul Znaiden, Trumbull, CT (US); Tomoko Kurita, Tochigi (JP); Yoshiharu Ashizawa, Saitama (JP); Srinivasan Krishnan, Union City, NJ (US); Chizu Kosaka, Tochigi (JP); Pushker Sona, Mumbai (IN); Simone Dosu Sethna, Mumbai (IN)

Correspondence Address: UNILEVER, PATENT DEPARTMENT, 45 RIVER ROAD, EDGEWATER, NJ, 07020, US

(73) Assignee: Unilever Home & Personal Care USA, Division of Conopco, Inc.

(21) Appl. No.: 10/607,493

(22) Filed: Jun. 26, 2003

(51) Int. Cl. G01C 3/10

(52) U.S. Cl. 33/494

(57) ABSTRACT

A color ruler for objectively measuring skin color and methods of using same. The color ruler has a scale with indicia of at least two different color attributes captured in a medium, the scale having been determined by the following steps:

(i) Taking multiple photographs of multiple subjects;

(ii) Sorting said photographs, thereby classifying them according to said color attributes to obtain sorted data;

(iii) Analyzing said sorted data;

(iv) Selecting at least one representative image;

(v) Transforming the representative image to create equal intervals and remove imperfections; and

(vi) Validating said color ruler by checking the correlation between the visual score given by use of the color ruler and the chromameter measurement.

A cosmetic product system is also provided which includes a cosmetic composition for skin lightening and a color ruler device packaged with the composition. Also provided is a method for assessing skin color attributes on the color ruler scale, for evaluating progress of skin lightening occurring over a period of time within which the composition is applied to an area of skin being monitored, and for product selection guidance.

### BACKGROUND OF THE INVENTION

1. Field of the Invention

The invention concerns a color ruler device, methods of using the color ruler, and a kit including a color ruler device packaged with a composition.

2. The Related Art

The ultimate goal of a cosmetic composition for skin lightening or brightening, as well as that of any cosmetic product or method, is a satisfied consumer. In cosmetic skin lightening, a consumer is seeking some degree of visible skin lightening. While many cosmetic products advertise skin lightening benefits, consumers usually cannot easily discern whether the claimed benefit is actually delivered, or a quantitative extent to which it is delivered.

Color instruments are known for color measurements in L-a-b color space according to Commission Internationale de l'Eclairage (CIE) standard. Although the color instruments are very useful and provide objective data, visual assessment is also important in evaluating skin lightening efficacy. After all, it is consumers (human eyes) that evaluate the efficacy of skin lightening products. Therefore, for visual assessment of color, it is essential to have a tool as an objective scale for grading.

Phillips et al., “Efficacy of 0.1% Tazarotene Cream for the Treatment of Photodamage,” Arch Dermatol, vol 138, p1486-1493 (November 2002) describes a 5 point scale (0:none-4: severe), noticeable to patients and investigators, for measuring hyper-pigmentation and other conditions.

Japan Color Research Institute has launched a skin tone color product which can be seen at http://plaza16.mbn.or.jp/˜JCRI/seihin/skintone.htm, however skin texture is not shown in this product which appears to have simply been based on paints.

A scale for evaluating wrinkles is disclosed in Tsukahara et al., “A Photographic Scale for the Assessment of Human Facial Wrinkles,” J. Cosmet. Sci., 51:127-139 (March/April 2000). However, no objective scale for evaluating facial color is reported.

Accordingly, there is a need for a tool for the objective visual measurement of attributes of human skin color. Applicants have developed a color ruler device, system, and methods that can be used (1) as a clinical tool to evaluate the efficacy of skin lightening products, (2) as a consumer tool to determine the degree of change that is meaningful and ideal to the consumer, (3) as a consumer clinical tool to measure the effectiveness of products from a consumer and clinical perspective, and (4) as a point of purchase device to allow a consumer a simple method to evaluate before and after treatment changes in skin color. The ruler provides the ability to define the distribution of skin color in a specific population, set technical and consumer targets, and allows the consumer a simple method to measure the effect.

Moreover, the color ruler was made from a photograph of actual skin, so that it looks more natural and more like real skin than any product that may have been commercially available.

### SUMMARY OF THE INVENTION

The present invention provides such a tool for visually assessing skin color on an objective scale. A color ruler according to the present invention is a collection of at least two representative images that capture the scope and nature of human skin color. The color ruler has a scale with indicia of at least two different color attributes captured in a medium, the scale having been determined by the following steps:

(i) Taking multiple photographs of each of a plurality of subjects;

(ii) Sorting said photographs, thereby classifying them according to said color attributes to obtain sorted data;

(iii) Analyzing said sorted data;

(iv) Selecting at least one representative image;

(v) Transforming the representative image to create equal intervals and remove imperfections; and

(vi) Validating said color ruler by checking the correlation between the visual score given by use of the color ruler and the chromameter measurement.

Among possible color ruler devices are those where the medium on which the color ruler scale is embodied is the Internet, camera, palm pilot, mobile phone; mobile phone with camera, advertising and promotional material, including television, magazines, brochures, posters, flyers, and hand-outs; and/or water-insoluble substrate. Water-insoluble substrate includes a strip, a double strip, or a sliding ruler alone or in combination with a mirror. Water-insoluble substrate may be made from a material including cellulosic, plastic, mirror or combination material.

A cosmetic product system is provided which includes:

(i) a cosmetic composition for skin lightening housed in a package; and

(ii) a color ruler device associated with said package;

the device having a means for evaluating current appearance of facial skin lightness or progress in skin lightening with the use of said cosmetic composition. The color ruler device comprises a scale having indicia of at least two different color attributes captured in a medium as described above.

Where the medium is a strip, it may be placed into a carton alongside a container holding the cosmetic composition or may be incorporated as a panel segment of a carton protectively surrounding a container holding the cosmetic composition or may be detachably joined to a carton protectively surrounding a container holding the cosmetic composition, such as by joinder through a means such as perforations, weakened carton wall and adhesive joinder.

Further, there is provided a method for evaluating attributes skin color on an area of facial skin and/or the efficacy of a cosmetic product for skin lightening, including:

(A) providing a kit which comprises the system as described above;

(B) applying the cosmetic product to the skin;

(C) placing said color ruler device against the skin treated with the cosmetic product in step (B);

(D) visually assessing a score on said color ruler scale; and

(E) repeating steps (C) and (D) at a future time followed by comparison of scores resultant from first and second assessments of the skin.

The evaluation is advantageously a self-evaluation by a consumer or an evaluation by a clinician, beautician, make-up artist, or sales assistant.

### BRIEF DESCRIPTION OF THE DRAWINGS

Additional objects, features and benefits of the present invention will become more readily apparent from consideration of the drawing in which:

FIG. 1A is a representation of a one-dimensional color ruler scale;

FIG. 1B is a representation of a two-dimensional color ruler scale;

FIG. 2 is a first embodiment of a color ruler device according to the present invention, i.e., as a strip;

FIG. 3 is a second embodiment of a color ruler device according to the present invention, i.e., a double strip;

FIG. 4 is a third embodiment of a color ruler device according to the present invention, i.e., a ruler adjacent a mirror; and

FIG. 5 is a fourth embodiment of a pore ruler device according to the present invention, i.e., a ruler with a double mirror.

### DETAILED DESCRIPTION OF THE INVENTION

Now consumers have been provided with a test device for objectively determining skin color at any point in time. Skin color determinations may be made in a natural state prior to application of any products application and/or for viewing short-term progress by application of a foundation or make-up and/or measuring progress on efficacy of the cosmetic composition over a prolonged period of its. Applicants have developed a color ruler device, system, and methods that can be used (1) as a clinical tool to evaluate the efficacy of skin lightening products, (2) as a consumer tool to determine the degree of change that is meaningful and ideal to the consumer, (3) as a consumer clinical tool to measure the effectiveness of products from a consumer and clinical perspective, and (4) as a point of purchase device to allow a consumer a simple method to evaluate before and after treatment changes in skin color. The ruler provides the ability to define the distribution of skin color in a specific population, set technical and consumer targets, and allows the consumer a simple method to measure the effect. The color ruler is made from a photograph of actual skin, so that it looks natural and more like real skin.

A cosmetic product system is also provided, including a cosmetic composition packaged together with a simple diagnostic color ruler device.

The color ruler device is based on the establishment of a clinical grading scale relevant to consumer perception. Accordingly, the ruler device of the present invention is a consumer perceivable, clinically usable tool for the assessment of facial skin color. It may be applied for consumer self-evaluation or for evaluation by a clinician, beautician or sales associate.

As used herein, the term “cosmetic composition” is intended to describe compositions for topical application to human skin, including leave-on and wash-off products.

The term “skin” as used herein includes the skin on the face, neck, chest, back, torso, arms, axillae, hands, legs, and scalp.

As used herein, “color” is a general term intended to cover human perception of color and includes variations in lightness/darkness and/or variations in hue.

Lightness is defined in terms of the L* parameter in the L*-a*-b* color space, which will be discussed in more detail hereinbelow. The greater the L* value, the lighter the skin. The smaller the L* value, the darker the skin, indicating higher melanin content.

Hue is defined as the color component on a red to yellow spectrum. On the color ruler, hue is defined in terms of the a* and b* parameters in L*-a*-b* color space, as follows:

Hue=tan⁻¹(b*/a*)

Usually for skin color, a* and b* are greater than zero, so the smaller the Hue value, the more red the color.

Scale

The present invention is based on a scale for objectively assessing attributes of skin color on an area of human skin. One hundred facial cheek images were collected and an image with even and averaged, i.e., median skin tone was selected. This averaged image was digitally treated to generate 9 skin tones with different lightness. More particularly, the development of the color ruler of the present invention will be discussed in more detail herein below.

### One-Dimensional Color Ruler Scale

A face color ruler scale based on cheek color measurements was developed. Cheek color measurements were collected using the following Photography Protocol.

Photography Protocol. 100 Japanese female subjects were photographed using a digital camera under optimized and controlled lighting conditions and camera settings. The women were asked to remove their facial makeup before being photographed. The photos were obtained with the women's faces oriented at 45 degrees to the camera, i.e., positioned in a reproducible manner and orientation. The digital images were then burnt on a CD-R and consistently printed on A4 size photo paper, i.e, “life” size, on the Epson MC-5000® color printer. The settings on the printer were optimised to closely match the color of the images when viewed on a FlexScan T766® calibrated color monitor, available from Eizo, Japan.

The subjects were photographed in duplicate in each position.

Sorting Protocol. The 100 printed photographs were placed into 9 bins by 9 evaluators in decreasing order of perceivable skin lightness. It took about 1.5 to 3 hours per evaluator to complete the exercise. The evaluators adopted one of many ways to achieve the sorting. Whereas a few evaluators started off by splitting the stack into 3 bins (i.e.) low, medium and high, before further classifying each of the bins until they arrived at the final result of 9 bins. Other evaluators began by identifying the extremes in condition of perceivable color, and then worked their way through the middle. Irrespective of the method adopted, the evaluators were always instructed to end up with 9 color bins that were representative of differences in perceivable color. In addition, the evaluators were also asked to identify one single photograph per bin that was most representative of the images in that bin.

The selection of images for the color ruler consisted of the following steps:

1. Select “representative” images out of each bin

2. Attain high agreement (low standard deviations) as to the selected images across the different evaluators

3. Select those images that provide equal steps between neighboring bins

4. Iterate between graders until agreement is reached.

About 90% of the evaluators were in agreement among themselves within one “color bin”. At this point, the color ruler consisted of 9 images from photos of individual cheeks.

These photos were good for capturing overall distribution of skin color. However, other features and texture of skin (uneveness, spots, pores, fine lines, acne, etc.) were considered to be hindrances in using the images for color ruler. Therefore, the Sorting was followed by Image Selection and Transformation, as follows.

Image Selection Protocol. Cheek area (about 3×3 cm) was cut out. One of the most even-colored and average (median) toned images was selected.

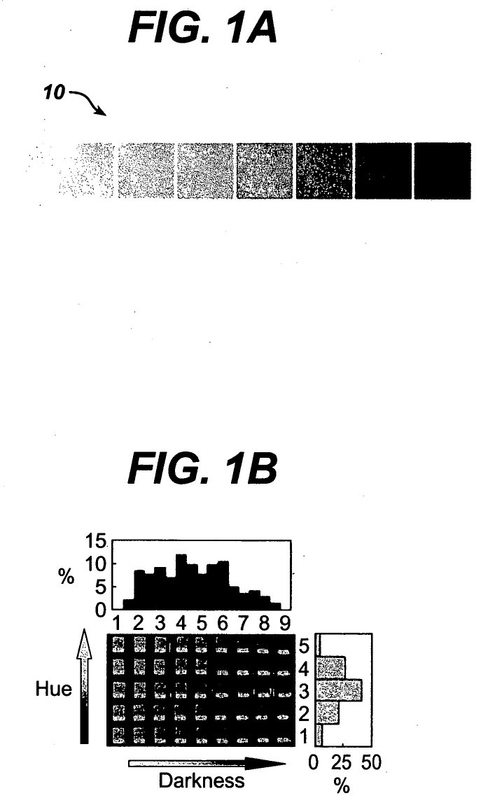

Transformation Protocol. To improve evenness to avoid distraction by imperfections unrelated to color and to provide equal steps between neighboring images on the scale, the color ruler was transformed. To this end, the images were modified by digital treatment, using Photoshop brand software available from Adobe company, http:\\www.adobe.com. To change the color of an original image, from the menu bar, the following consecutive selections were made: Image->Adjust->Hue/Saturation. Three vectors in HSL color space, i.e., Hue, Saturation, and Lightness (HSL color space) were thereby varied. The images thereby created were semi-artificial but had skin texture. FIG. 1A represents a color ruler scale 10 thereby developed, according to one embodiment of the present invention.

The color ruler scale was validated by comparing measurements by visual assessment on the color ruler scale with instrumental color measurements. The correlation among visual assessment using the color ruler and instrumental readings of L-value (measured by a colorimeter), which is indicative of melanin content, was found to be good, with high correlation (r>0.90).

Validation Protocol. The 1 D face color ruler was used in clinical tests and it was confirmed through measurements by clinicians that the 1 D face color ruler works well. Face color of approximately 150 Japanese women was assessed by naïve consumers using the color ruler. A normal distribution, such as a bell curve distribution, in lightness and was obtained to confirm the color ruler represents facial skin color. For the 2D color ruler, a normal distribution was also obtained for hue, as shown in FIG. 1A. In other words, the color ruler was validated by checking the correlation between the visual score given by use of the color ruler and the chromameter measurement.

### Two-Dimensional Color Ruler Scale

A two-dimensional color ruler, i.e., along two axes, was developed to capture the wide distribution in Hue of facial cheeks.

One hundred cheek images were collected according to the Photography Protocol described herein above. One image with even and averaged (median) skin tone was selected using the Sorting and the Image Selection Protocols described herein above, and further by agreement among the 9 graders on a single representative image.

The representative image was digitally treated using the Transformation Protocol described herein above in order to generate 9 skin tones with different lightness on one axis and different hue on another axis, at even intervals. The transformation was performed on the basis of L*-a*-b* color space. This color system is known as the Commission Internationale de l'Eclairage (CIE) L*a*b* color system, where:

L*=Black to white (luminance) from 0 to 100 [L*=0 represents Black]

a*=green to red from −60 to +60

b*=blue to yellow from −60 to +60

as measured by a chromameter, such as for example a hand held Minolta CM2002 chromameter.

The 2D (2-dimensional or 2 axes) face color ruler was developed by shifting the lightness and hue of the representative image 4 steps in each direction on each the Lightness and the Hue axis. A two-dimensional color ruler scale 11 thereby developed, according to another embodiment of the present invention, is shown in FIG. 1B. The axis showing lightness represents the L* variation from darker (lower L* value) to lighter (higher L* value). The axis showing Hue is a red to yellow spectrum.

On the color ruler, hue is defined in terms of the a* and b* parameters in L*-a*-b* color space, as follows:

Hue=tan⁻¹(b*/a*)

The smaller the Hue value, the redder (a, b>0).

To validate the 2D color ruler, the Validation Protocol described above again worked well and resulted in a normal distribution.

The color ruler may further be customized to reflect on a scale of at least 2 points the nuances in skin color and hue of a given population.

The results above show that the color ruler is a consumer perceivable ruler, and can be used in studies for assessment of skin color.

Device

Color ruler devices include a scale having indicia of at least two different colors captured in a medium in order to allow to visually assess skin color in an objective manner. Examples of such medium include the computer, Internet, camera, palm pilot, mobile phone, water-insoluble substrate, or advertising and promotional material including television, magazines, brochures, posters, flyers, and hand-outs.

Several possible embodiments of the color ruler device having a water-insoluble substrate are as follows.

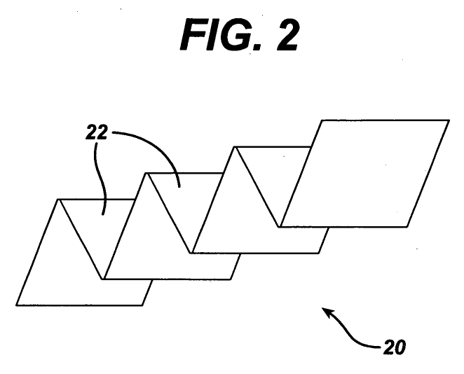

With reference to FIG. 2, in a first embodiment the device according to the present invention, color ruler device 20 is a strip having a plurality of color ruler scales 22 represented thereon. Color ruler device 20 may be folded into a concertina, or accordion arrangement, for compactness and/or easier insertion onto a package.

Color ruler device 20 strips for use with the illustrated embodiment will be articles allowing observation and comparison of the condition of skin color with the color ruler scale 22. Suitable materials for the strip are paper and plastics or cellulosics of any variety thereof which can be formed as transparent films. Preferred paper material is “half-gloss” photographic paper, sold under the Epson PM/MC brand and available from Epson.

When the substrate is made of plastic, typically the plastic may be selected from polyethylene, polypropylene, polystyrene, polyester, polycarbonate, polyacrylate, polyvinyl chloride, polyvinyl alcohol and polybutene. Not only homopolymers but copolymers may be utilized for the strip material. Copolymers may be formed from such monomers as C₂-C₁₀ olefins, vinyl chloride, acrylates and styrene constructed through free-radical polymerization. Condensation plastics may also be utilized in the formation of copolymers wherein the monomers may be selected from C₂-C₁₀ dicarboxylic acids, C₂-C₁₀ polyols, C₂-C₆ alkoxylates and combinations thereof. Polyethylene, polypropylene and polyester terephthalate are the preferred plastic substrates for forming the strip.

The substrate may also include ceramic material, such as tiles and back-lit illumination systems with cellulose and glass.

Color ruler device 20 strips may be made of combinations of the materials above. Preferably, to achieve texture very similar to that of stratum corneum, half-gloss photographic paper covered with Scotch Tape brand adhesive tape.

The thickness of the strip may range anywhere from about 0.00001 to about 2 mm, preferably from about 0.0001 to about 1 mm, more preferably from about 0.001 to about 0.5 mm and optimally from about 0.01 to about 0.1 mm.

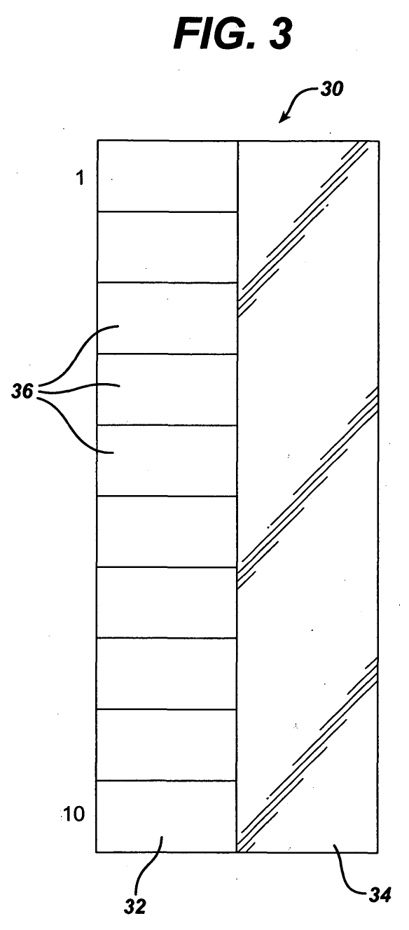

With reference to FIG. 3, in a second embodiment according to the present invention, color ruler device 30 is double strip having half 32 adjacnt other half 34. The color ruler half 32 has a plurality of images on scale 36. Adjacent half 34 may be a transparent material as described above with reference to FIG. 2. Color ruler device 30 may be made of the materials described herein above with reference to device 20.

Half 34 of device 30 may also have a mirrored surface or other reflective surface, advantageously eliminating the need for a user to find a mirror. In use, a user may place device 30 against her skin and, in the case of transparent half 34, compare her skin to scale 36 while looking in a mirror. In the case of half 34 being a reflective surface, a user may look into the reflective surface and compare her skin in the reflective surface against scale 36.

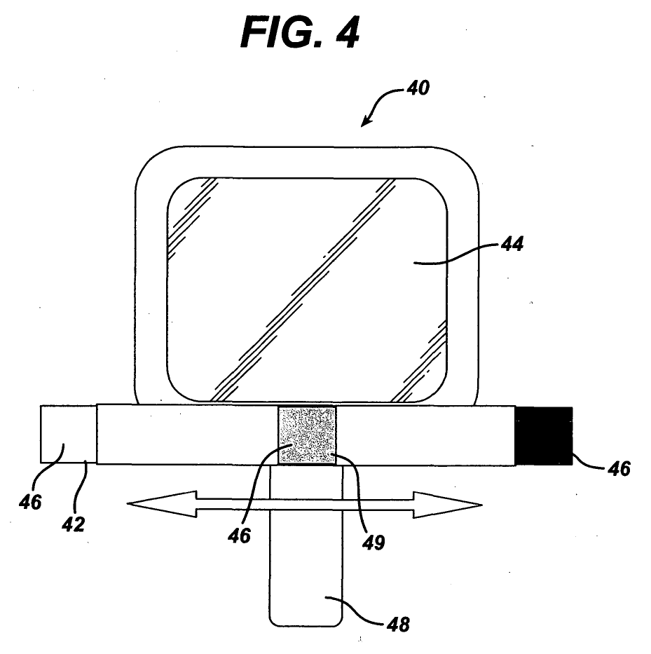

With reference to FIG. 4, in a third embodiment of color ruler device 40 according to the present invention, a sliding ruler 42 having a plurality of color attributes on scale 46 is provided in combination with at least one mirror 44. Sliding ruler 42 has a handle 48 having a slit 49 therein. Sliding ruler 42 is attached by handle 48 and positioned adjacent, and in this case, under mirror 44. An image on color ruler scale 46 can be seen from slit 49 by sliding ruler 42. Sliding ruler 42 may also be positioned in any configuration other than under mirror 44. Additionally, ruler 42 may be semi-transparent and embedded on mirror 44. A user will find an image 46 representative of her condition on ruler 42 by superimposing an area of her skin on scale images 46 on mirror 44. An advantage of this embodiment is that a user does not need to separately find a mirror to practice the methods of the present invention.

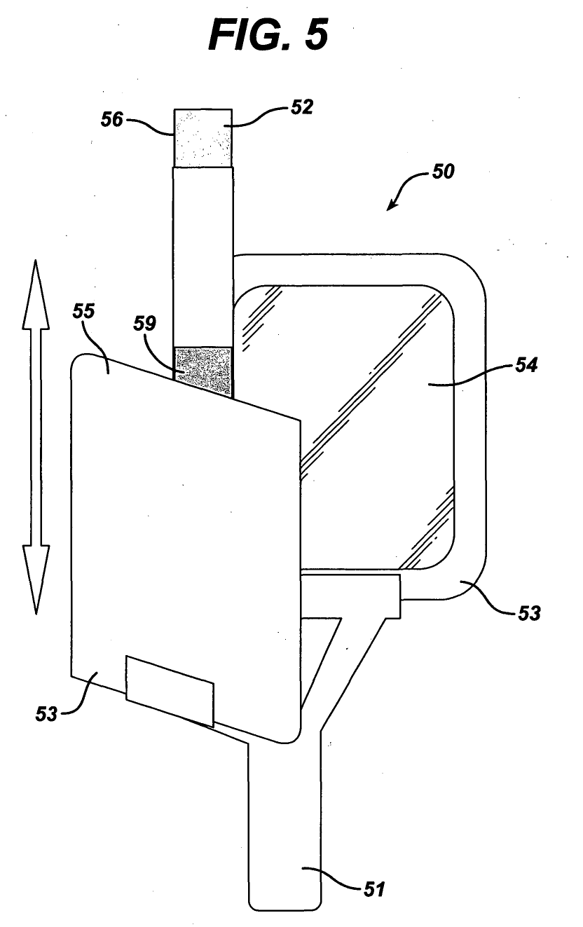

With reference to FIG. 5, in a fourth embodiment of color ruler device 50 according to the present invention, a sliding ruler 52 having a plurality of color attributes on scale 56 is provided in combination with two mirrors 53 positioned at an angle to each other and held on pedestal 51. Each mirror 53 has a reflective mirror surface 54 and a rear mirror portion 55. Sliding ruler 52 has a handle 58 (not shown) having a slit 59 therein. Sliding ruler 52 is attached by handle 58 and positioned adjacent one of mirrors 53 and an image on a color ruler scale 56 can be seen from slit 59 by sliding ruler 52. Sliding ruler 52 may also be positioned in any configuration other than adjacent one of mirrors 53. Additionally, ruler 52 may be semi transparent and embedded on mirror surface 54. A user will find an image on ruler 52 by superimposing an area of their skin on scale images 56 on one or both mirror surfaces 54. An advantage of this embodiment is that a user does not need to separately find a mirror to practice the methods of the present invention. Another advantage of this embodiment is the ability to see oneself at multiple angles which is possible with the two mirrors.

Cosmetic Compositions

Cosmetic compositions according to the present invention may be in the form of creams, lotions, toners, pastes, sticks (e.g. lipsticks), or powders. These cosmetics normally will include a carrier. Suitable carriers include water, emollients (esters, hydrocarbons, silicones, polyols and mixtures thereof), emulsifiers, thickeners and combinations thereof. Most often the carrier will be an emulsion such as an oil-in-water or water-in-oil type. Amounts of the carrier may range from about 1 to about 99.9% by weight.

Skin lightening agents or actives include kojic acid and esters, ferulic acid and ferulate derivatives, vanillic acid and esters, dioic acids (such as sebacic and azoleic acids) and esters, retinol, retinal, retinyl esters, hydroquinone, t-butyl hydroquinone, mulberry extract, licorice extract, and resorcinol derivatives, especially 4-substituted resorcinol derivatives.

The following additional skin benefit agents may optionally be used and include: astringents, humectants, acne and sebum suppressants, desquamation enhancers, keratolytics, and make-up, among other pore reduction actives known to one skilled in the art. Examples of astringents include ethanol, witch hazel, zinc and aluminum salts, and polyphenols. Humectants include propylene glycol (available from Spectrum) glycerol, and sorbitol, among other humectants known to one skilled in the art. Humectants are known as excellent moisturizers for skin, scalp and hair. See for instance, U.S. Pat. No. 5,858,340, incorporated by reference herein.

Other skin benefit agents may be included as optional components. Anti-aging actives may include retinoids, ceramides, alpha or beta-hydroxycarboxylic acids, flavonoids, vitamins, sunscreens, anti-oxidants, preservatives and mixtures thereof.

Typical retinoids include retinol, retinoic acid and retinol esters. The latter include retinyl palmitate, retinyl linoleate, retinyl propionate, retinyl acetate and retinyl salicylate.

Alpha-hydroxy acids include the free acid, lactone and salt forms of glycolic acid, lactic acid, citric acid, gluconolactone, glucarolactone, tartaric acid, malic acid and mixtures thereof. Beta-hydroxycarboxylic acids are exemplified by salicylic acid as well as its esters (e.g. tridecylsalicylate) and salts including ammonium, alkanolammonium and alkalimetal salts.

Ceramides include Ceramide 1, Ceramide 2, Ceramide 3, Ceramide 3a, Ceramide 3b, Ceramide 4, Ceramide 5 and Ceramide 6, as well as pseudoceramides, phytosphingosines and tetraacetyl phytosphingosine.

Vitamins may include ascorbic acid as well as its water-soluble and water-insoluble derivatives. Illustrative are ascorbyl tetraisopalmitate, magnesium ascorbyl phosphate and ascorbyl glucoside. Other vitamins include Vitamin B3 (niacin, niacinamide and panthenol), biotin, folic acid, tocopherol and its esters (e.g. tocopherol isopalmitate), Vitamin D and combinations thereof.

Antioxidants include BHT (butylated hydroxytoluene), BHA (butylated hydroxyanisole), disodium EDTA (available from Ciba), sodium citrate, hydroquinone, ferulic acid and esters thereof, green tea extract, lipoic acid, N-acetyl cysteine, resveratrol and combinations thereof.

Amounts of skin lightening actives may range anywhere from 0.0000001 to 30%, preferably from 0.0001 to 15%, more preferably from 0.1 to 5%, by weight.

System

Another aspect of the present invention provides a system wherein a cosmetic composition is packaged with a color ruler device. A variety of packaging arrangements is envisioned. A color ruler may be printed on the primary or secondary packaging. The test device may be incorporated as a panel segment of a carton, the latter protectively surrounding the cosmetic composition. In a variation thereof, the test device may be detachably joined to the package through a perforated or weakened construction line, or through an adhesive joinder.

Methods of Use

The inventive color ruler device, system, and methods can be used (1) as a clinical tool to evaluate the efficacy of skin lightening products, (2) as a consumer tool to determine the degree of change that is meaningful and ideal to the consumer, (3) as a consumer clinical tool to measure the effectiveness of products from a consumer and clinical perspective, and (4) as a point of purchase device to allow a consumer a simple method to evaluate before and after treatment changes in skin color. The ruler provides the ability to define the distribution of skin color in a specific population, set technical and consumer targets, and allows the consumer a simple method to self-assess the effect.

Specifically, the color ruler device may be used for determining the condition of skin color pre- and/or post-treatment or cosmetic product application, or to track changes in skin color associated with a variety of factors, such as cosmetic product usage and/or sun exposure. Pre-treatment color ruler measurements may be used in selecting an appropriate cosmetic product. For example, different product formulations may be recommended depending on the individual condition as measured on the color ruler. Color ruler indicia may be printed directly on the package for this purpose, or represented in other media within the scope of the present invention.

Subsequent to a baseline analysis of skin on the color ruler device, a make-up product is applied and/or treatment is begun with a selected cosmetic product for skin lightening. Treatment is continued for a period of time sufficient to allow the product to lighten the skin.

After the treatment period of time, such as four weeks, another color ruler measurement is taken. Testing may occur thereafter at 8, 12, 16 and/or 20 weeks. The time intervals and numbers may be longer or shorter. If the cosmetic product is properly functioning, skin will appear lighter on the color ruler device and the color ruler score will be lower. This procedure can then be repeated at six or eight weeks or at any further time interval. Each test may employ the same or a fresh color ruler device or a new color ruler device or ruler medium.

The color ruler device may be used in conjunction with a variety of media for displaying or embodying the color ruler scale. These media include in or out of home use of strips as described hereinabove, the computer, Internet, webcam, palm pilot, mobile phone, and other media capable of displaying the color ruler scale. A color ruler scale of at least 2 points and as many as 6 to 9 or more points may be printed directly on the package. A strip embodying a color ruler scale may be given out to consumers at point of sale or at a store display.

The color ruler may be used as a clinical tool to set lightening or brightening goals and/or to support skin lightening product claims on the package. The color ruler may also be used by beauticians and make-up artists to select an appropriate foundation or other make-up application. The color ruler provides an objective clinical grading scale, whereby each image is associated with a numerical scale.

Except in the operating and comparative examples, or where otherwise explicitly indicated, all numbers in this description indicating amounts of material ought to be understood as modified by the word “about”.

For the avoidance of doubt, he term “comprising” is meant not to be limiting to any subsequently stated elements but rather to encompass non-specified elements of major or minor functional importance. In other words the listed steps, elements or options need not be exhaustive. Whenever the words “including” or “having” are used, these terms are meant to be equivalent to “comprising” as defined above.

All parts, percentages and proportions referred to herein and in the appended claims are by weight unless otherwise illustrated.

### EXAMPLE 1

This example illustrates that an evaluation of pre- and post-treatment skin color is possible using the color ruler scale, suggesting the validity and usefulness of the device and method of the present invention.

An agent for skin lighening, 4,6-di-isopropyl resorcinol, was evaluated using a 9 point scale on the color ruler device.

Good results were obtained. Consumers perceived a difference on the color ruler scale. The color ruler score showed an improvement from 6 to 5.

### EXAMPLE 2

This example illustrates the use of the color ruler device as a consulting tool at point of purchase. Three different product formulations were available for consumers, depending on their color ruler measurements. The color ruler was printed on the package. On a 9 point scale, measurements 1-3 represented the lightest skin condition on the scale and consumers with these conditions would be pointed to the weakest composition for skin lightening. Measurements 4-6 represented medium skin color and consumers with these conditions would be pointed to a medium strength product. Consumers with the darkest skin conditions, with measurements 7-9 on the color ruler scale, would be pointed to the strongest formulation or regimen for the skin lightening.

### EXAMPLE 3

This example illustrates the use of the color ruler for determining the condition of the skin pre- and post-treatment over the Internet. A consumer took a photograph, i.e., electronic image, of her face using a mobile phone with built-in camera, transmitted the electronic image to a Color Ruler website capable of correlating a given image with those on the color ruler scale. A color ruler scale measurement was phoned back to the consumer through the Internet, a measurement of 5 on the color ruler scale, thereby establishing a color measurement of the pre-treatment condition.

Subsequently, the consumer applied a Fair & Lovely brand product over a period of about four weeks. Another electronic photograph was taken using the same mobile phone with built in camera and again transmitted through the Internet. This time the color ruler measurement transmitted back to the consumer through the Internet measured 3, indicating a significant lightening of the skin.

### EXAMPLE 4

Color ruler device 20 as shown in FIG. 2 was imprinted with images of color ruler scale 22, folded into a concertina, or pamphlet and placed in a package containing a composition for skin lightening. For compactness and ease of fit into a package, color ruler scale 22 consisted of representations of skin color on the cheek area.

### EXAMPLE 5

This example demonstrates the utility of the color ruler scale to define consumer preferences, by having them choose current, ideal, and product expectation level of from the 9 color ruler images.

During the color ruler validation study described herein above, the consumers were also asked to pick out an image (out of the 9 images of the ruler) that most represented their current skin color condition. They were then asked to pick an image that represented their “ideal” end point from a product as well as what would be an image that they would like to go to with a product in order for them to buy the product. Thus, the color ruler served as a tool to generate purchase intent in consumers.

The results suggested that consumers' ideal skin condition is almost as low as color ruler scale 1, that is a good 4.3 steps lower than their current condition on a 9 point scale. The consumers expect a 3.2 step improvement from a cosmetic product.

### EXAMPLE 6

This example describes an additional validation study performed to gain confidence in the color ruler scale.

1. Facial skin on the right side cheeks of 144 Japanese females (n=144), ages 18-72, was assessed using a 9 point ruler scale. Normal distribution was seen, and the data are shown in the Table below, i.e., the number of subjects in each color grade. The average visual grade was 4.93.

TABLE 1

| | visual | |
|---|---|---|
| X | grade | n |
| 1 | 1-1.5 | 3 |
| 2 | 2-2.5 | 14 |
| 3 | 3-3.5 | 23 |
| 4 | 4-4.5 | 25 |
| 5 | 5-5.5 | 30 |
| 6 | 6-6.5 | 29 |
| 7 | 7-7.5 | 12 |
| 8 | 8-8.5 | 7 |
| 9 | 9 | 1 |

2. The color of the same site on each female subject was measured by color instrument. The correlation between visual grade and instrumental readings (L*) appears linear, The original formula of the correlation was: 2.576/(square root ((n−1)+3)), with the correlation coefficient of 0.77, which corresponded to more than 99% confidence level by statistics. (In case of the number of subject is 144, r=more than 0.22 corresponds to 99% confidence level by statistics.)

In sum, good correlation was seen between the visual grade by color and the instrumental readings, to a more than 99% confidence level.

The foregoing description and examples illustrate selected embodiments of the present invention. In light thereof variations and modifications will be suggested to one skilled in the art, all of which are within the spirit and purview of this invention. It is intended that all of these modifications and variations be within the scope of the present invention as described and claimed herein, and that the inventions be limited only by the scope of the claims which follow, and that such claims be interpreted as broadly as is reasonable. Throughout this application, various publications have been cited. The entireties of each of these publications are hereby incorporated by reference herein.

1. A color ruler device comprising a scale having indicia of at least two different color attributes captured in a medium, wherein said scale is determined by a method comprising the following steps:
(i) Taking multiple photographs of multiple subjects;
(ii) Sorting said photographs, thereby classifying them according to said color attributes to obtain sorted data;
(iii) Analyzing said sorted data;
(iv) Selecting at least one representative image;
(v) Transforming said representative image to create equal intervals and remove imperfections; and
(vi) Validating said color ruler by checking the correlation between the visual score given by use of the color ruler and the chromameter measurement.

2. The color ruler device according to claim 1, wherein said medium is selected from the group consisting of Internet, camera, palm pilot, mobile phone, mobile camera phone, water-insoluble substrate and advertising and promotional material selected from the group consisting of television, magazines, brochures, posters, flyers, and hand-outs.

3. The color ruler device according to claim 2, wherein said water-insoluble substrate comprises a strip, a double strip, or a sliding ruler alone or in combination with a mirror.

4. The color ruler device according to claim 2, wherein said water-insoluble substrate comprises a material selected from a cellulosic, plastic, mirror or combination material.

5. (cancelled)

6. (cancelled)

7. (cancelled)

8. (cancelled)

9. (cancelled)

10. (cancelled)

11. (cancelled)

12. (cancelled)

13. (cancelled)

14. A method of evaluating attributes of skin color on an area of human skin comprising:
(A) providing a color ruler device according to claim 1;
(B) comparing said area of skin with said indicia on said color ruler scale to categorize said area of skin on said scale.

15. The method according to claim 12, further comprising placing said color ruler against the skin prior to said product application.
